(19) United States
(12) Patent Application Publication
(10) Pub. No.: US 2026/0224969 A1
(43) Pub. Date: Aug. 6, 2026

(54) CONNECTION ELEMENT FOR CONNECTING SKIS AND SKI POLES

(71) Applicant: Levian Innovations - FZCO, Dubai (AE)

(72) Inventor: Ruben Lévi BOELHOUWERS, Amsterdam (NL)

(73) Assignee: Levian Innovations - FZCO, Dubai (AE)

(21) Appl. No.: 19/155,106

(22) PCT Filed: Feb. 8, 2024
(86) PCT No.: PCT/NL2024/050063

§ 371 Date: Aug. 8, 2025

(30) Foreign Application Priority Data
Feb. 8, 2023 (NL) 2034113

(51) Int. Cl. A63C 11/02; G10K 5/00

(52) U.S. Cl. CPC A63C 11/025; G10K 5/00

(57) ABSTRACT

Title: Connection element for connecting skis and ski poles An assembly (100) comprising two skis (201, 202) and two ski poles (203, 204), the assembly further comprising a connection element (102) coupling the skis and the ski poles, the connection element comprising:
a connection element body (104);
a ski connection module (110) connecting the two skis to the connection element body;
a ski pole connection module (103) connecting the two ski poles to the connection element body;
   wherein the skis and the ski poles are positioned on opposite sides of the connection element.

### TECHNICAL FIELD

The aspects and embodiment thereof relate to the field of skis, ski poles, and connection elements for connecting skis and ski poles.

### BACKGROUND

Skiing has been a popular sport and leisure activity for centuries. Ski poles are an important part of skiing, providing balance and stability. Typically, a person skiing requires two skis and two ski poles. Because of their shape, skis and ski poles can be difficult to carry by a single person.

Solutions have been proposed to connect two skis and two ski poles together to form a single assembly which can be carried around. In particular, the assembly comprises a connection element which allows the ski poles to be used as a handle for carrying around the skis. As such, the skis are suspended below the ski poles via the connection element, and the connection element is positioned such that it is positioned above the ski poles—to prevent the weight of the skis from disconnecting the ski poles from the connection elements.

### SUMMARY

It is an object of the present disclosure to provide for an improved connection element for connecting one or more, in particular two, ski poles to one or more, in particular two, skis. Improvements are preferred in terms of ease-of-use, in particular how convenient skis and/or ski poles can be connected and/or disconnected from the connection element, and/or in terms of safety of the connection element. A further object of the present disclosure is to provide for a connection element for connecting one or more, in particular two, ski pole-like bodies, such as walking poles, to another body, such as a backpack.

A first aspect provides an assembly comprising two skis and two ski poles, the assembly further comprising a connection element coupling the skis and the ski poles, the connection element comprising a connection element body, a ski connection module connecting the two skis to the connection element body, a ski pole connection module connecting the two ski poles to the connection element body, wherein the skis and the ski poles are positioned on opposite sides of the connection element.

The assembly allows a user to carry the skis for example on their shoulder, and thereby also carrying the ski poles which are connected to the skis via the connection element.

When the ski poles and skis are disconnected from the connection element, preferably, no further elements used to form the connection between the ski poles and the skis remain connected to the ski poles and skis.

Preferably, the assembly comprises at most one connection element coupling the skis and the ski poles. As such, the user is only required to carry around a single connection element for example while skiing.

The connection element may be positioned at a distance from the centre of gravity the skis. In the known connection elements, the skis are suspended below the ski poles and as such the connection elements have to be positioned at the centre of gravity of the skis for stabilities. However, in the assembly according to the first aspect, the skis are preferably supported on the shoulder of the user and optionally supported by one hand of the user. This allows the connection element to be positioned at a distance from the centre of gravity the skis, which in turn may increase the convenience with which the assembly can be formed or disassembled. Additionally or alternatively, the connection element may be positioned at a distance from the centre of gravity the ski poles.

In any embodiment of the assembly disclosed herein, and for any connection element disclosed herein, the connection element may comprise a protrusion protruding away from the connection element body, which protrusion is at least partially positioned in-between the two skis. The protrusion may prevent or reduce movement between the skis and the connection element. A movement of the connection element and the skis may otherwise be caused for example by the weight of the ski poles, which are typically in use positioned above the skis, with the connection element in-between the ski poles and the skis. However, it is also envisioned that in use the ski poles are positioned below the skis, or even alongside the skis.

When a connection element comprises the protrusion, the protrusion may extend from the connection element body up to a distance corresponding to at most half of a width of the skis, in particular at most a quarter of the width of the skis or even at most 15% of the width of the skis. In general, a shorter protrusion is preferred as this reduces the volumetric footprint of the connection element. A smaller connection element may increase safety during skiing for example when the connection element is carried in the pocket of a jacket and the skier would accidentally fall onto the connection element. The protrusion may for example protrude at most 50 mm, at most 30 mm or even at most 20 mm from the connection element body.

Any ski connection module disclosed herein may comprise a ski connection member which is wrapped around the skis. This may allow for a convenient manner for the use to connect the skis to the connection element. Furthermore, in particular when the ski connection member is adjustable in length, many different sizes of skis may be connected to a single size of connection element. The ski connection member may comprise one or more flexible strips, such as one or more flexible bands, rope-like elements, webbing, bands, belts, or any other type of flexible strip.

When in use the ski connection member forms a closed shape encircling a volume, and the skis and part of the connection element body may be positioned in the volume encircled by the ski connection member. Preferably, the volume encircled is adjustable. The ski connection member can pass through the connection element body, one time or multiple times. To this end, for example, one or more passages may be provided through the connection element body.

In any connection element disclosed herein, the ski pole connection module may be formed by two snap-fit sections of the connection element body, each of the snap-fit sections forming a space into which a respective one of the ski poles is positioned. Alternatively, for example the ski pole connection module may be arranged to clamp the ski poles to the connection element body.

When snap-fit sections of the connection element body form a space into which a respective one of the ski poles may be positioned, an opening may be provided into each of the spaces. Preferably, but not necessarily, the openings face away from the skis. This allows the ski poles to be supported or even cradled by the connection element, for example when in use the skis are carrier on the shoulder of the user, with the ski poles positioned above or below the skis.

When the connection element comprises the protrusion and openings into spaces of snap-fit sections, the openings may face in a generally opposite direction as a direction in which the protrusion protrudes away from the connection element body.

Additionally or alternatively, at least part of the ski connection module may be positioned between the spaces formed by the ski pole connection module. This may allow for a compact design of the connection element

A second aspect provides a connection element for connecting two ski poles and two skis, the connection element comprising a connection element body, a ski connection module for connecting the two skis to the connection element body, and a ski pole connection module for connecting the two ski poles to the connection element body.

For any connection element of the present disclosure, preferably the ski connection module and ski pole connection module face in opposing direction. This allows the skis and the ski poles to in use be positioned on opposite sides of the connection element.

It will be appreciated that the present disclosure contemplates connection elements with any combination of features disclosed for connection elements comprised by any assembly according to the first aspect.

A third aspect provides an assembly comprising a backpack and two walking poles, the assembly comprising a backpack, two walking poles, and a connection element connecting the walking poles to the backpack, the connection element comprising:
a connection element body;
a walking pole connection module connecting the two walking poles to the connection element body;
a backpack connection module connecting the backpack to the connection element body;

wherein the backpack and the walking poles are positioned on opposite sides of the connection element, and a flexible strip, such as a webbing, extends through a passage or tunnel through the connection element body.

It will be appreciated that any feature disclosed in conjunction with the connection element according to the second aspect may be readily applied to a connection element used in the assembly according to the third aspect.

### BRIEF DESCRIPTION OF THE FIGURES

In the figures,

FIG. 1A shows part of an assembly;

FIG. 1B shows a schematic section view of the assembly of FIG. 1A;

FIGS. 2A and 2B schematically show an example of a connection element for coupling skis and ski poles, respectively in an isometric view and a side view;

FIGS. 3A-3C show an embodiment of a connection element body;

FIGS. 4A-4C show another embodiment of a connection element body;

FIGS. 5 and 6 show a user carrying an assembly of skis and ski poles; and

FIG. 7 shows another assembly,

### DETAILED DESCRIPTION OF THE FIGURES

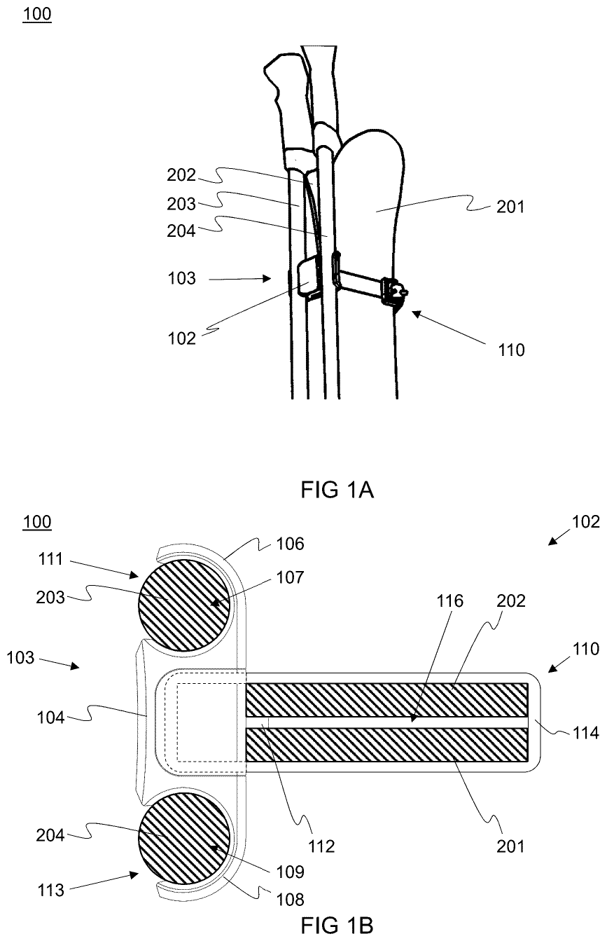

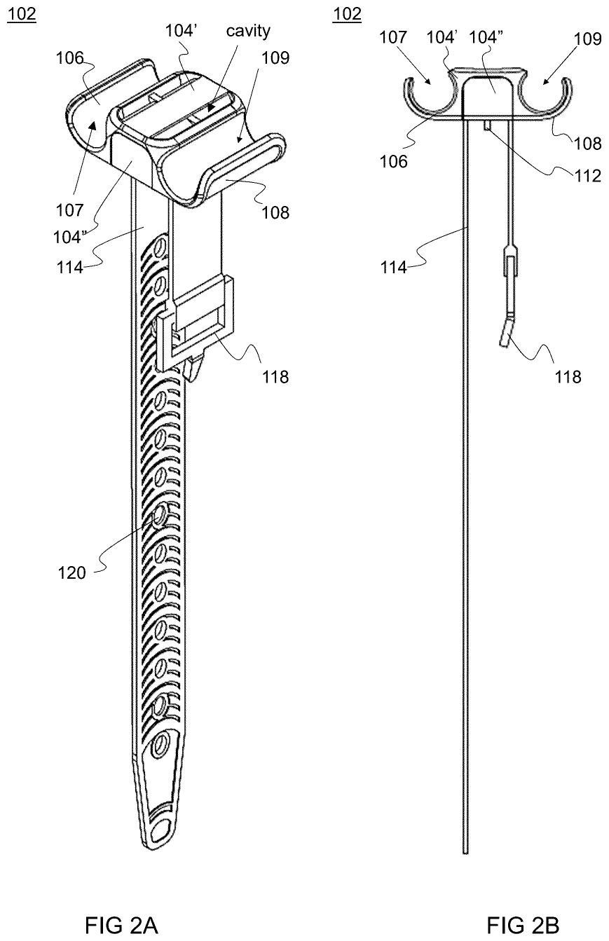

FIG. 1A shows part of an assembly 100 comprising two skis 201, 202 and two ski poles 203, 204, the assembly further comprising a connection element 102 coupling the skis and the ski poles. FIG. 1B shows a schematic section view of the assembly 100, with the skis 201, 202 and ski poles 203, 204 shown hatched.

As can be seen in FIGS. 1A-1B, the connection element 102 allows the skis and the ski poles to be carried together, for example by placing the skis on a user's shoulder, with the ski poles positioned above or below the skis. In general, it may be preferred to only use a single connection element 102 coupling the skis and the ski poles, instead of using multiple separate connection elements 102—although the use of multiple separate connection elements 102 is also envisioned by the present disclosure. However, when only a single connection element 102 is used, the user has to carry around less items, for example while skiing. As an option depicted in FIG. 1A, part of the ski poles, such as at least part of the handles, can extend beyond the skis. However, in other embodiments the ski poles do not extend beyond the skis—for example depending on the length of the skis and the ski poles.

As depicted in FIG. 1A, the connection element 102 may be positioned near an outer end of the skis 201, 202—or at least at a distance from a centre of gravity of the skis 201, 202. Alternatively or additionally, the connection element 102 is positioned near the handles of the ski poles 202, 203—or at least at a distance from a centre of gravity of the ski poles. This applies to any embodiment of the assembly 100 disclosed herein using any connection element 102.

FIG. 1B shows the connection element 102, which comprises a connection element body 104, a ski connection module 110 for connecting two skis to the connection element body 104, and a ski pole connection module 106, 108 for connecting two ski poles to the connection element body 104. The connection element body 104 may generally be formed a single monolithic body, or may conceivably be formed by two or more elements which are connected, for example using a threaded connection, glued connection, welded connection, clamped connection, and/or any other type of connection.

As a particular option, applicable to any connection element 102 disclosed herein, and depicted for example in FIG. 1B, the connection element 102 comprises a protrusion 112 protruding away from the connection element body 104. In use, for example when the assembly 100 of FIG. 1B is formed, the protrusion 112 is positioned in-between the two skis. The protrusion 112 aims to prevent or restrict movement of the connection element 102 relative to the skis 201, 202. In particular, the protrusion 112 can prevent the connection element 102 from rotating about a rotation axis generally parallel to the elongation axis of the skis.

The inventor has found that the protrusion 112 does not need to be as long as the width of the skis 201, 202. Instead, the protrusion 112 may extend from the connection element body 104 up to a particular distance which is smaller than the width of the skis. In particular, the distance may correspond to at most half of a width of the skis, in particular at most a quarter of the width of the skis or even at most 15% of the width of the skis. The smaller the distance, in general the easier it will become to store the connection element 102 when not in use, for example in a pocket of jacket or trousers or in a backpack, in particular while skiing.

For any embodiment of the connection element disclosed herein, the ski connection module 110 may comprise or even be formed as a ski connection member 114 arranged to be wrapped around the skis, as for example depicted in FIGS. 1A and 1B. When the ski connection member 114 is connected to the connection element body 104 and the ski connection member 114 is wrapped around the skis 201, 202, the skis can be held in place relative to the connection element body 104.

It will be appreciated that being wrapped around in the context of the present disclosure does not necessarily mean that the ski connection member is fully wrapped around the entire circumference of the skis. Instead, the ski connection member may be partially wrapped—or, in other words, partially wound—around the outer circumference of the skis.

In general, whenever a ski connection member 114 is used for the ski connection module 110, the ski connection member 114 may form a closed shape encircling a volume 116. Inside this volume 116, in use, the skis and part of the connection element body 104 can be positioned. The skis and the connection element body 104 can as such become trapped by the ski connecting member 114, which ski connecting member 114 thus restricts or prevents movement between the skis and the connection element body 104.

It will be appreciated that when part of the connection element body 104 is positioned inside the volume 116 encircled by the ski connection member 114, part of the ski connection member 114 can pass through the connection element 104—as schematically shown by the dashed part of the ski connection member 114 in FIG. 1B.

For any ski connection member 114 disclosed herein, the ski connection member 114 may be formed by a single body. Alternatively, the ski connection member 114 may be formed by multiple distinct bodies, such as two bodies, which can be connected to form a continuous ski connection member 114 which can be wrapped around the skis. A body can be formed as a belt, strap, band and/or any other strip of flexible material.

Preferably, but not necessarily, a snap-fit connection is used to connect the ski poles to the connection element body. In particular, one snap-fit connection is used per ski poles, and as such the connection element 102 typically comprises two snap-fit connection as the ski pole connection module.

FIG. 1B shows an example of the assembly 100 in which a first of the ski poles 203 is connected using a first snap-fit connection, and a second of the ski poles 204 is connected using a second snap-fit connection. Both snap-fit connections are formed using the ski pole connection module 103 of the connection element 102.

The ski pole connection module 103 can be formed by two snap-fit sections 106, 108 of the connection element body 104. Each of the snap-fit sections 106, 108 forms a space 107, 109 into which a ski pole can be positioned. An opening 111, 113 is provided into both spaces 107, 109 through which a ski pole can be moved in order to position the ski pole in a space, and/or through which a ski pole can be moved in order to remove the ski pole from the space.

When a ski pole is moved into a space of a snap-fit section, preferably the snap-fit section is elastically deformed, for example in a generally hinging motion. As such, a snap-fit connection can be formed between the snap-fit section and the ski pole.

As an option depicted in FIG. 1B, at least part of the strap 114—or conceivably any other ski connection module 110—and/or the skis may be positioned between the spaces 107, 109 formed by the snap-fit section 106, 108. This may allow for a more compact design of the connection element 102.

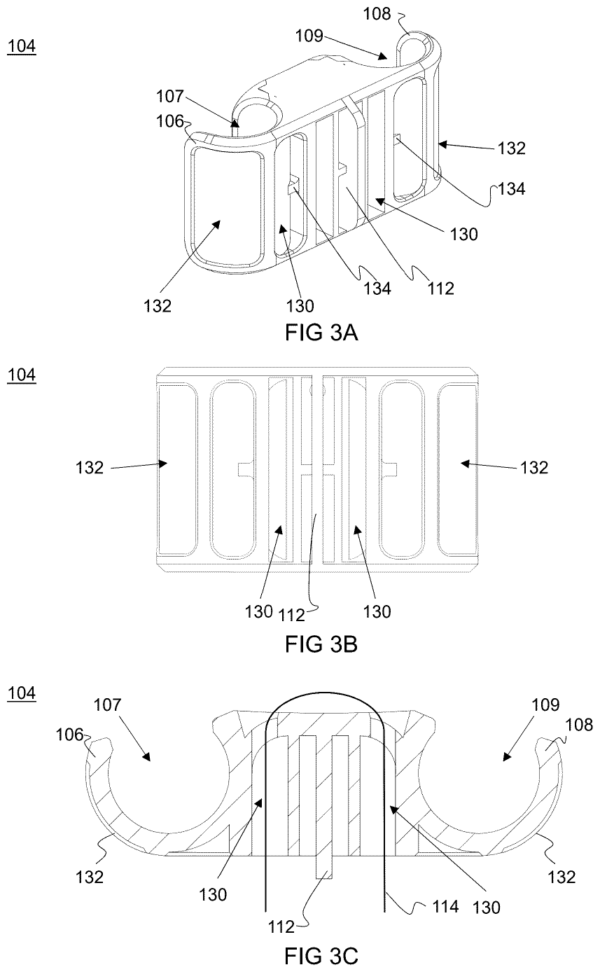

FIGS. 2A and 2B schematically show an example of a connection element 102 for coupling skis and ski poles, respectively in an isometric view and a side view.

As a particular example, applicable also to any other embodiment of the connection element 102 disclosed herein, the ski connection member 114 shown in FIGS. 2A and 2B is a strap 114 with a buckle 118 at one end, and one or more apertures 120 through the strap 114 with which the buckle 118 can be connected. The ski connection member 114 can be a ski strap. It will be appreciated that instead of the buckle and the apertures, other connections are envisioned to connect the ski connection member 114 with itself. For example, one or more of a hook-and-loop connection, ratchet connection, a clamped connection, a cam buckle, or any type of connection may be used.

Preferably, the length of the circumference of the ski connection member 114 when forming the closed shape can be adjusted, for example to accommodate different sizes of skis.

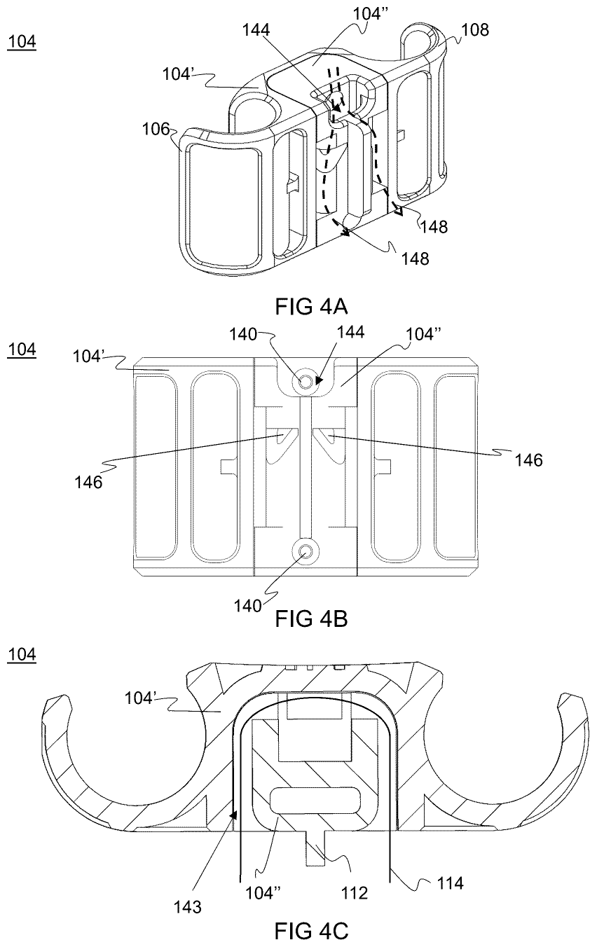

FIGS. 3A-3C show an example of a connection element body 104, which can be generally comprised by any connection element 112 disclosed herein, respectively in an isometric view, front view, and a section view. Options disclosed in conjunction with FIGS. 3A-3C can be readily applied to any other connection element body 114 disclosed herein. The connection element body 104 is in FIGS. 3A-3C depicted with the snap-fit section 106, 108.

As an option, but not necessarily, the connection element body 104 is formed as a single monolithic body. To allow a flexible strip to be used as a ski connection member, two passages 130 are allowing passage of the flexible strip through the connection element body 104. In FIG. 3C, the flexible strip is schematically indicated with curved line 114.

When the connection element body 104 comprises one or more snap-fit sections 106,108, such as for example depicted in FIGS. 3A-3C, one or more recessed sections 132 may be comprised by the connection element body 104 to allow elastic deformation of the snap-fit sections 106, 108. The recessed sections 132 are preferably positioned at an opposite side of the connection element body 104 than the spaces 107, 109. Additionally or alternatively, support ribs 134 may be comprised by the connection element body 104 to locally increase stiffness.

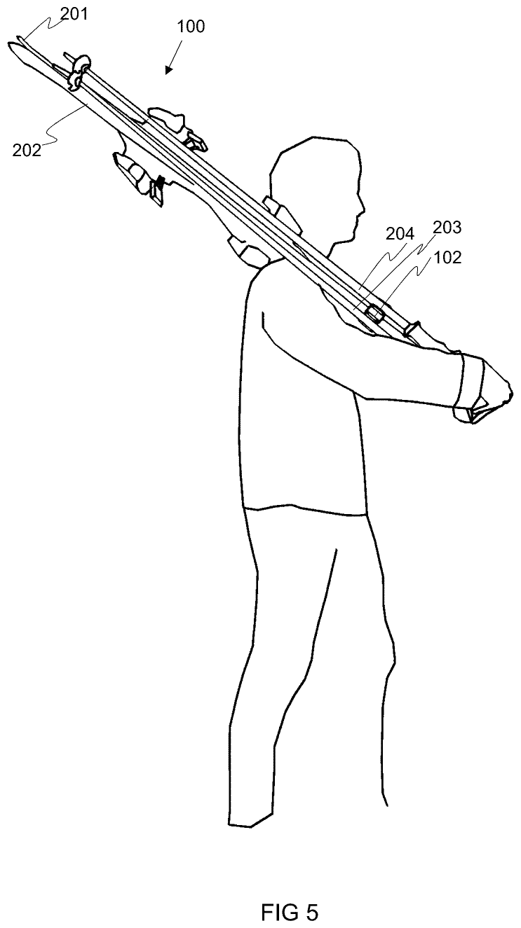

FIGS. 4A-4C show another example of a connection element body 104, which can be generally comprised by any connection element 112 disclosed herein, respectively in an isometric view, front view, and a section view.

As an option disclosed in FIGS. 4A-4C, the connection element body 104 can be formed from multiple connected bodies, for example a first body 104′ and a second body 104″. The first body 104′ may comprise the snap-fit sections 106, 108. As a further option best visible in the section view of FIG. 4C, the protrusion 112 may protrude from the second body 104″.

To connect the first body 104′ and 104″, as a particular option, a set of screws 140 may be used. Alternatively, any other threaded connection, a clamped connection, a glued connection, or any other type of connection or combination thereof may be used.

As is best visible in the section view of FIG. 4C, a tunnel 143 as an example of a passage may be formed between the first body 104′. As schematically shown, a ski connection member 114 may be passed through the tunnel 143. In particular, the use of a separate first body 104′ and second body 104″ allows the ski connection member 114 to be positioned between the first body 104′ and second body 104″ before connecting the first body and the second body.

As a preferred option, although not necessarily, applicable to any connection element body 104 disclosed herein, one or more air passages can be provided through the connection element body, forming a whistle. In particular, an air entrance 144 is formed into the connection element body 104, in particular in the second body 104″, and one or more air exits 146 are formed into the connection element body, in particular in the second body 104″. When an air flow 148 is constituted through the connection element body 104, between the air entrance 144 and the exits 146, a whistling sound may be produced. A whistle may aid a skier who is in an emergency and required assistance.

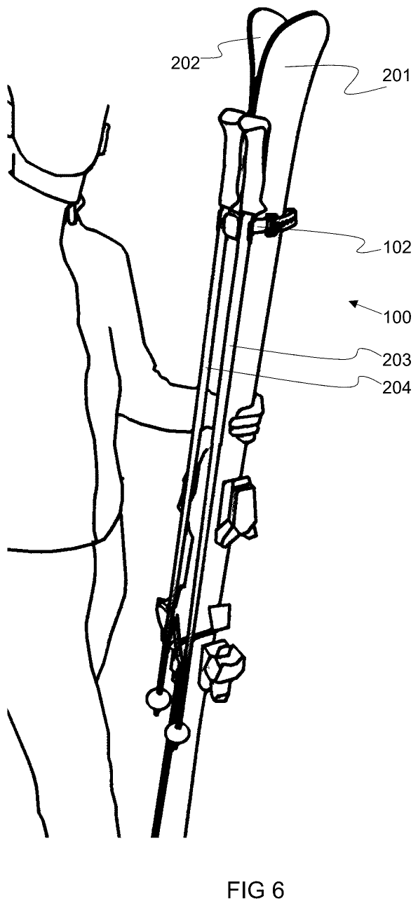

FIG. 5 shows an example of a user carrying an assembly 100 comprising two skis 201, 202 and two ski poles 203, 204. Advantageously, the skis and ski poles are coupled using a connection element 102, which may be any connection element of the present disclosure. The connection element couples the skis and ski poles such that the assembly can be carried on a shoulder of the user, optionally supported with one hand of the user leaving the other hand free to perform other actions.

The ski poles may be oriented with the handles downward—as shown in FIG. 5—but conceivable also with the handles upward. In use, one or both skis and/or one or both ski poles may be directly supported on the shoulder, in any combination thereof. Additionally or alternatively, in use, the connection element 102 can be positioned below the shoulder—as shown in FIG. 5—or above the shoulder.

FIG. 6 shows another example of a user carrying an assembly 100 comprising two skis 201, 202 and two ski poles 203, 204. Advantageously, the skis and ski poles are coupled using a connection element 102, which may be any connection element of the present disclosure. In the example of FIG. 6, the user holds the skis in one hand, and by virtue of the ski poles being connected to the skis via the connection element 102, the ski poles are indirectly also carried by the user—leaving the other hand free for other actions. Furthermore, when the assembly 100 is carried in a generally vertical orientation, a chance of accidentally hitting other objects or persons with the assembly 100 when the user rotates is reduced.

Both from FIGS. 5 and 6, it becomes apparent that the connection element according to present disclosure allows an assembly 100 to be formed which requires only a single connection element 102, connecting the skis and ski poles at a single location. This connection location may be positioned at a distance from the centre of gravity of the skis and the centre of gravity of the ski poles.

As for example visible in FIG. 6, when the skis and ski poles are positioned on opposite sides of the connection element 102, the ski poles and skis can be conveniently disconnected from the connection element 102.

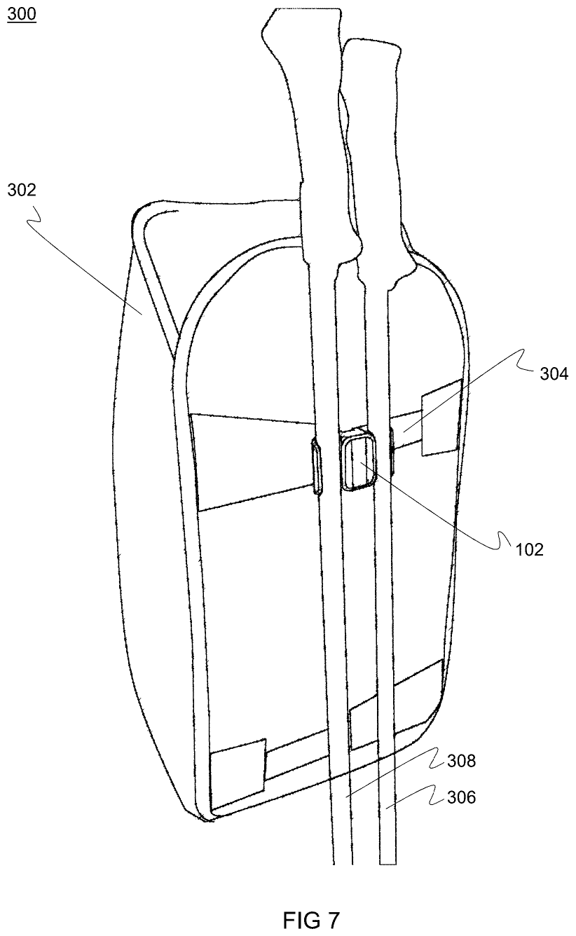

FIG. 7 shows an assembly 300 of a backpack 302 and two walking poles 306, 308. A connection element 102 is comprised by the assembly 300, to connect the walking poles 306, 308 to the backpack 302. The connection element 102 can be any connection element according to the present disclosure, wherein the connection element is connectable to a backpack instead of or in addition to skis.

Often, backpacks comprise webbing, straps, bands, or other flexible strips. A flexible strip 304 of the backpack can be connected the connection element 102, for example by passing the flexible strip 304 through a tunnel 143 or one or more passages 130 through the connection element 102—similar to the ski connection member 114. The walking poles 306, 308 can be connected to the connection element 102 in a similar manner as ski poles can be connected to the connection element 102, for example using the snap-fit connections. It will thus be understood that the ski pole connection module can be used as a walking pole connection module.

What is claimed is:

1. An assembly comprising two skis and two ski poles, the assembly further comprising a connection element coupling the skis and the ski poles, the connection element comprising:
a connection element body;
a ski connection module connecting the two skis to the connection element body;
a ski pole connection module connecting the two ski poles to the connection element body;
wherein the skis and the ski poles are positioned on opposite sides of the connection element.

2. Assembly according to claim 1, wherein the assembly comprises at most one connection element coupling the skis and the ski poles.

3. Assembly according to claim 1, wherein the connection element is positioned at a distance from the centre of gravity of the skis.

4. Assembly according to claim 1, wherein the connection element is positioned at a distance from the centre of gravity of the ski poles.

5. Assembly according to claim 1, wherein the connection element comprises a protrusion protruding away from the connection element body, which protrusion is at least partially positioned in-between the two skis.

6. Assembly according to claim 5, wherein the protrusion extends from the connection element body up to a distance corresponding to at most half of a width of the skis, in particular at most a quarter of the width of the skis or even at most 15% of the width of the skis.

7. Assembly according to claim 1, wherein the ski connection module comprises a ski connection member which is wrapped around the skis.

8. Assembly according to claim 7, wherein the ski connection member forms a closed shape encircling a volume, and the skis and at least part of the connection element body are positioned in the volume encircled by the ski connection member.

9. Assembly according to claim 7, wherein the ski connection member passes through the connection element body.

10. Assembly according to claim 1, wherein the ski pole connection module is formed by two snap-fit sections of the connection element body, each of the snap-fit sections forming a space into which a respective one of the ski poles is positioned.

11. Assembly according to claim 10, wherein an opening is provided into each of the spaces.

12. Assembly according to claim 11, wherein the openings face away from the skis.

13. Assembly according to claim 11, wherein the connection element comprises a protrusion protruding away from the connection element body, which protrusion is at least partially positioned in-between the two skis, and wherein the openings face in a generally opposite direction as a direction in which the protrusion protrudes away from the connection element body.

14. Assembly according to claim 10, wherein at least part of the ski connection module is positioned between the spaces formed by the ski pole connection module.

15. Connection element for connecting two ski poles and two skis, the connection element comprising:
a connection element body;
a ski connection module for connecting the two skis to the connection element body;
a ski pole connection module for connecting the two ski poles to the connection element body;
wherein the ski connection module and ski pole connection module face in opposing direction.

16. Connection element according to claim 15, further comprising a protrusion protruding away from the connection element body, which protrusion is arranged to be at least partially positioned in-between the two skis.

17. Connection element according to claim 16, wherein the protrusion extends from the connection element body up to a distance of up to 30 mm.

18. Connection element according to claim 15, wherein the ski connection module comprises a ski connection member which is arranged to be wrapped around the skis.

19. Connection element according to claim 18, wherein the ski connection member passes through the connection element body.

20. Connection element according to claim 18, wherein the ski connection member comprises a flexible strip, such as a ski strap.

21. Connection element according to claim 15, further comprising one or more air passages through the connection element body forming a whistle.

22. Assembly comprising a backpack and two walking poles, the assembly comprising a backpack, two walking poles, and a connection element connecting the walking poles to the backpack, the connection element comprising:
a connection element body;
a walking pole connection module connecting the two walking poles to the connection element body;
a backpack connection module connecting the backpack to the connection element body;
wherein the backpack and the walking poles are positioned on opposite sides of the connection element, and a flexible strip, such as a webbing, extends through a passage or tunnel through the connection element body.

23. Connection element suitable for use in an assembly according to claim 1.
